(19) United States
(12) Patent Application Publication
(10) Pub. No.: US 2014/0129248 A1
(43) Pub. Date: May 8, 2014

(54) USAGE BASED SYSTEM FOR MONITORING A MEDICAL IMAGING DEVICE

(71) Applicants: Sven Zuehlsdorff, Westmont, IL (US); Bruce S. Spottiswoode, Chicago, IL (US); Aaron Flammang, Tustin, CA (US)

(72) Inventors: Sven Zuehlsdorff, Westmont, IL (US); Bruce S. Spottiswoode, Chicago, IL (US); Aaron Flammang, Tustin, CA (US)

(21) Appl. No.: 14/072,838

(22) Filed: Nov. 6, 2013

Related U.S. Application Data
(60) Provisional application No. 61/723,420, filed on Nov. 7, 2012.

(51) Int. Cl. G06F 19/00

(52) U.S. Cl. CPC G06F 19/321
USPC 705/2

(57) ABSTRACT

A system for profiling operational usage associated with a plurality of medical imaging devices includes an information container processor, a database, a data analyzer module, and an output processor. The information container processor is configured to acquire operational data from each of a plurality of customer entities. The operational data acquired from each respective customer entity may include, for example, an identification of a imaging device used by a respective customer entity; a configuration setting associated with the imaging device; and an identification of one or more of an imaging scanning method utilized by the imaging device, an anatomical region imaged by the imaging device, and a medical condition investigated using the imaging device. The database is configured to store the operational data acquired from each respective customer entity. The data analyzer module is configured to generate one or more usage inquiries; using the database and the usage inquiries, derive one or more findings regarding the operational data acquired from each respective customer entity; and identify a significant finding included in the one or more findings. The output processor is configured to communicate data indicating the significant finding to a destination.

### CROSS-REFERENCE TO RELATED APPLICATIONS

This application claims priority to U.S. provisional application Ser. No. 61/723,420 filed Nov. 7, 2012 which is incorporated herein by reference in its entirety.

### TECHNICAL FIELD

The present invention relates generally to methods, systems, and apparatuses for monitoring customer usage of medical equipment and clinical applications to derive information for user-specific optimizing of that equipment, as well as related clinical and equipment services. The technology is particularly well-suited to, but not limited to, optimizing customer usage of imaging devices such Magnetic Resonance (MR), Computed Tomography (CT), or Positron Emission Tomography (PET) scanners.

### BACKGROUND

Conventional recommendation systems provide filtered information and seek to predict a rating that a user would give to an item or service. These systems use techniques such as collaborative filtering based on historical interactions alone or content-based filtering that utilizes predetermined profile attributes. The systems may be used to derive personalized recommendations (e.g., based on individual behavior), social recommendations (e.g., based on behavior of similar users), or item recommendations (e.g., based on an item or service). Companies utilizing recommendation systems use sophisticated methods to anticipate user interest in specific products and optimize services, such as replenishing of consumables.

In conventional medical imaging systems, logged data is used to monitor the state of hardware and software. For instance, in some Computed Tomography (CT) scanners, software and sensors log information regarding the health status of an X-ray tube (a critical hardware element) to predict the need for replacement or to anticipate failures of the tube. As a result, the downtime of scanners is reduced significantly because device servicing may be scheduled at times with minimal impact on clinical service. While these system-based monitoring systems have been beneficial to the efficiency of the medical imaging systems, additional benefits may be achieved by providing customizing and tailoring of medical imaging system features for specific users. Thus, there is a need to apply the techniques of recommendation systems to medical imaging systems.

### SUMMARY

Embodiments of the present invention address and overcome one or more of the above shortcomings and drawbacks, by providing methods, systems, and apparatuses for monitoring the usage of medical equipment and specific clinical applications to derive information for use in optimizing the equipment, applications, and related systems in a user-specific manner. The technology is particularly well-suited to, but not limited to, monitoring the usage of imaging devices such Magnetic Resonance (MR), Computed Tomography (CT), or Positron Emission Tomography (PET) scanners.

Embodiments of the present invention are directed at a system for profiling operational usage associated with a plurality of medical imaging devices. The system includes an information container processor, a database, a data analyzer module, and an output processor. The information container processor is configured to acquire operational data from each of a plurality of customer entities. In some embodiments, the operational data is acquired by receiving a device log file from each of the plurality of customer entities and parsing the received log files to identify the operational data. In one embodiment, the customer entities comprise at least one of, (a) a hospital, (b) a group of hospitals, (c) a hospital department, (d) a medical facility, (e) an individual user, and (f) a group of users. The operational data acquired from each respective customer entity may include, for example, an identification of an imaging device used by a respective customer entity; a configuration setting associated with the imaging device; and/or an identification of one or more of an imaging scanning method utilized by the imaging device, an anatomical region imaged by the imaging device, and a medical condition investigated using the imaging device. The database in aforementioned system is configured to store the operational data acquired from each respective customer entity. The data analyzer module is configured to generate one or more usage inquiries and, using the database and the usage inquiries, derive one or more findings regarding the operational data acquired from each respective customer entity. This module is further configured to identify a significant finding included in the one or more findings. The output processor is configured to communicate data indicating the significant finding to a destination.

In some embodiments of the aforementioned system, the data analyzer module is configured to perform additional functionality. For example, in one embodiment, the data analyzer module is further configured to identify an imaging system feature to offer one or more of the customer entities in response to identification of the significant finding. In another embodiment, the data analyzer module is further configured to identify an operational problem in response to identification of the significant finding and to identify an operational change to an imaging device to correct the operational problem.

In the aforementioned system, the operational data acquired from each respective user may vary. For example, in one embodiment, the operational data further comprises data identifying one or more of: frequency of use of particular hardware included in the imaging device; frequency of use of the imaging scanning method; and a distribution of anatomical regions imaged by the imaging device. In another embodiment, the operational data further comprises data identifying one or more of: duration of an individual imaging examination; imaging system failures; a distribution of anatomical regions imaged by the imaging device; and data identifying a type of imaging examination performed for a particular anatomical region. In yet another embodiment, the operational data further comprises one or more of image quality indicators, entity preferences, and a type of specialization of a hospital using the imaging device.

Other embodiments of the present invention are directed at a system for analyzing usage information associated with a plurality of medical devices, the system comprising: a usage information database, a plurality of inquiry modules, a plurality of processing modules, and a results module. The usage information database includes a plurality of usage information records, each usage information record corresponding to a respective medical device and a user of the respective medical device. These inquiry modules may include, for example, a user inquiries module configured to process single one-time requests regarding users of the medical devices, a scheduled inquiries module configured to process scheduled inquiries regarding the users of the medical devices, and a data mining module configured to automatically process one or more unsolicited inquiries regarding the users of the medical devices. The plurality of processing modules may be operably coupled to the inquiry modules and configured to receive one or more results of the inquiries and derive one or more findings. The results module is configured to categorize the one or more findings as significant or insignificant. In some embodiments, the results module is further configured to transmit a feedback message to one or more of the users of the medical devices. In some embodiments, the system also includes a market analysis module configured to derive a market analysis metric based on information stored in the usage information database.

With respect to the inquiry modules referenced above with respect to the aforementioned system, the various requests processed by each module may vary according to the different embodiments of the present invention. The one-time requests may include, for example, one or more of: a first request for how often an imaging technique is performed by a specific user of a specific one of the medical devices; a second request for how often the imaging technique is performed by each of a first group of users utilizing their corresponding medical devices; a third request for how usage of the imaging technique by each of a second group of users has changed over a time period; and a fourth request for identifiers associated with a third group of users performing the imaging technique using their corresponding medical devices. The scheduled inquiries may include, for example, a first status inquiry requesting hardware status information corresponding to the medical devices and/or a second status inquiry requesting software status information corresponding to the medical devices. The unsolicited inquiries may include, for example, a request for identification of a correlation between a first parameter and a second parameter based on usage information stored in the usage information database.

In several embodiments, additional processing modules may be used in the aforementioned system. For example, additional processing modules may include one or more of a correlation module configured to calculate cross-correlations between two or more variables included in the usage information records; a trend identification module configured to identify a trend across a sample of first data points included in the usage information records; an outlier identification module configured to identify second data points included in the usage information records that are outside of a predetermined confidence interval; and a benchmarking module configured to determine benchmarking information based on a predetermined percentile of third data points included in usage information records. The details of how these modules are implemented may vary across different embodiments. For example, in one embodiment, the cross-correlations calculated by the correlation module identify groups of users performing a specific technique using the medical devices. In one embodiment, the trend identification module is further configured to identify an increase or decrease of use of a specific technique by a specific user of a specific one of the medical devices.

According to other embodiments of the present invention, an article of manufacture for profiling operational usage of a plurality of medical imaging devices includes a tangible, non-transitory computer-readable medium holding computer-executable instructions for performing a method which includes acquiring operational data from each of a plurality of customer entities. The operational data acquired from each respective customer entity may include, for example an identification of a imaging device used by a respective customer entity; a configuration setting associated with the imaging device; and/or an identification of one or more of an imaging scanning method utilized by the imaging device, an anatomical region imaged by the imaging device, and a medical condition investigated using the imaging device. The method further includes storing the operational data acquired from each respective customer entity and generating one or more usage inquiries. Next, using the database and the usage inquiries, one or more findings are derived regarding the operational data acquired from each respective customer entity. A significant finding included in the one or more findings may then be identified and communicated to a destination.

The aforementioned article of manufacture may be modified, enhanced, or augmented in various embodiments to support imaging system features. For example, in some embodiments, the method performed by the article of manufacture further comprises identifying an imaging system feature to offer one or more of the plurality of customer entities in response to identification of the significant finding. In another embodiment, the method further comprises identifying an operational problem in response to identification of the significant finding and identifying an operational change to an imaging device to correct the operational problem. In another embodiment, the operational data is acquired from each of a plurality of customer entities by receiving a device log file from each of the plurality of customer entities and parsing the received log files to identify the operational data.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 provides a system diagram illustrating a Usage Monitoring System and related components, according to some embodiments of the present invention;

FIG. 2 provides a flow chart illustrating operation of the Usage Monitoring System 105, according to some embodiments of the present invention;

FIG. 3 provides a XML file showing how usage data may be formatted for transfer to the information container for the example of a MRI study, according to some embodiments of the present invention;

FIG. 4 is a block diagram of Information Container, as implemented in some embodiments of the present invention;

FIG. 5 provides a detailed view of the Data Analyzer, as implemented in some embodiments of the present invention; and

FIG. 6 illustrates an exemplary computing environment within which embodiments of the invention may be implemented.

### DETAILED DESCRIPTION

The following disclosure describes the present invention according to several embodiments directed at methods, systems, and apparatuses for monitoring usage of medical equipment and specific clinical applications to derive information for user specific optimizing of medical imaging and other systems identifying improvements to clinical and equipment services. The technology is particularly well-suited to, but not limited to, monitoring the usage of imaging devices such Magnetic Resonance (MR), Computed Tomography (CT) or Positron Emission Tomography (PET) scanners.

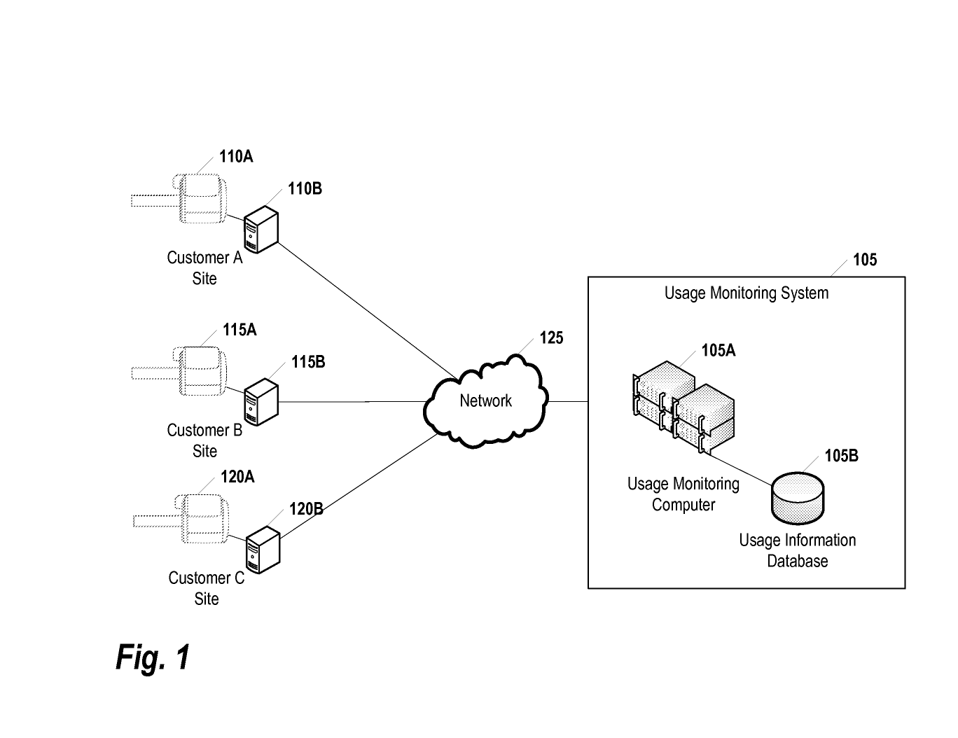

FIG. 1 provides a system diagram illustrating a Usage Monitoring System 105 and related components, according to some embodiments of the present invention. In the example of FIG. 1, there are three customer sites (labeled Customer A Site, Customer B Site, and Customer C Site, respectively). At each customer site, there is a medical device (110A, 115A, and 120A) and a computer (110B, 115B, 120B) for connecting with the Usage Monitoring System 105 over a network 125. The medical devices 110A, 115A, and 120A located at each site may include, for example, imaging devices such as Magnetic Resonance (MR), Computed Tomography (CT), or Positron Emission Tomography (PET) scanners. Any other medical device known in the art may also be employed at the customer sites and connected to the Usage Monitoring System 105 over the network 125. The computers 110B, 115B, 120B located at each site communicate with their respective medical devices (110A, 115A, and 120A) to gather operational data regarding how the particular device is being used. This operational data is collectively referred to herein as a “usage information” or “usage data.” In some embodiments, the medical devices 110A, 115A, and 120A are configured to generate specialized filed (e.g., in XML format) detailing usage information. In other embodiments, the computers 110B, 115B, 120B are configured to parse log files generated by their respective medical devices to generate files containing the usage information. In other embodiments, the log files are sent directly from computers 110B, 115B, 120B to the Usage Monitoring Computer 105A. Then, the Usage Monitoring Computer 105A handles the processing of the log files to determine usage information.

Continuing with reference to FIG. 1, the computer network 125 connecting the various customer sites with the Usage Monitoring System 105 may be implemented with a variety of hardware platforms. For example, the computer network 125 may be implemented using the IEEE 802.3 (Ethernet) or IEEE 802.11 (wireless) networking technologies, either separately or in combination. In addition, the computer network 125 may be implemented with a variety of communication tools including, for example, TCP/IP suite of protocols. In some embodiments, the computer network 125 is the Internet. A virtual private network (VPN) may be used to extend a private network across the computer network 125. Usage information received by the Usage Monitoring System 105 is processed by a Usage Monitoring Computer 105A and stored in a Usage Information Database 105B. The Usage Information Database 105B may be implemented, for example, using a database package such as Microsoft Access™ or a DBMS such as Microsoft SQL Server™, mySQL or postgreSQL.

As noted above, in some embodiments, information is communicated between customer sites and the Usage Monitoring System 105 in the form of usage data. Usage data may include various information regarding how a respective medical device is being used at a customer site. For example, in one embodiment, the usage data includes items such as, without limitation, an identification of a imaging device used by a respective customer entity, a configuration setting associated with the imaging device, an identification of one or more of an imaging scanning method utilized by the imaging device, an anatomical region imaged by the imaging device, and a medical condition investigated using the imaging device. The exact data acquired may vary according to the medical device. For example, for MR imaging devices, the usage data may provide an indication of the use of Gradient Recalled Echo (GRE), Steady State Free Precession (SSFP), non-contrast enhanced magnetic resonance angiography (non-CE MRA), susceptibility weighted imaging (SWI), Day Optimizing Throughput (DOT), viewing applications, and/or post-processing applications. For CT imaging devices, the usage data may provide information regarding the use of one or more of mAs, kVP, and filtration. Additionally, some usage data (e.g., time of last use) may be common across all sampled devices.

The contents of the usage data acquired from each medical device will vary based on myriad factors. The specific data acquisition that is utilized may depend on information such as, without limitation, the modality, patient, body region, clinical indication, and available (e.g., purchased or leased) options for the specific medical device. For example, sequences to visualize morphology of the brain are typically standard on MR scanners. Therefore, usage data associated with these sequences may be available for a large group of medical devices. Conversely, niche or dedicated methods (e.g. susceptibility weighted imaging) for specific patient groups (e.g. patients with Multiple Sclerosis) are options that may need to be acquired by the customer and, thus, the usage data associated with these methods may have limited availability across all the sampled medical devices.

In some embodiments, where the medical device is an imaging device, the usage data provides an indicator of which body regions are being imaged by the device. Thus, for example, the usage data may provide an indication that the imaging device is typically used for cranial, neck, spine, heart, pelvis, or whole body imaging. The type of examination may also be specified for each body region. For example, if the usage data indicates that an imaging device is typically used for heart imaging, the data may also provide an indication that the imaging is used for the treatment of conditions such as, without limitation, Heart Failure (HF), Myocardium Infarction (MI), Myopathies, and/or valve disease.

Usage data may also comprise an indication of how often specific hardware such as, without limitation, RF coils, physiological measurement systems, communication system, power injector, or other peripheral hardware is used. In some embodiments, usage data also includes information about the duration of exams (e.g., patient preparation time or scanner activity), and or quality information (e.g., ECG signal, imaging data signal quality, quality, or scan repeats). In some embodiments, usage data also includes information on customer preferences gathered, for example, from a “like/dislike” buttons presented on the imaging device itself or on a website affiliated with the company providing the imaging (e.g., hospital or medical facility information) or the company that designed and manufactured the imaging device (e.g., Siemens, GE, or Phillips). In some embodiments, usage data provides information that may be used to monitor components of the respective imaging devices for wear or failures. For example, with respect to MR imaging systems, usage data may include information on the state of gradient power amplifiers. For CT imaging devices, the usage data may provide information on the state of the X-ray tubes, generators, gantries, or photomultiplier tubes.

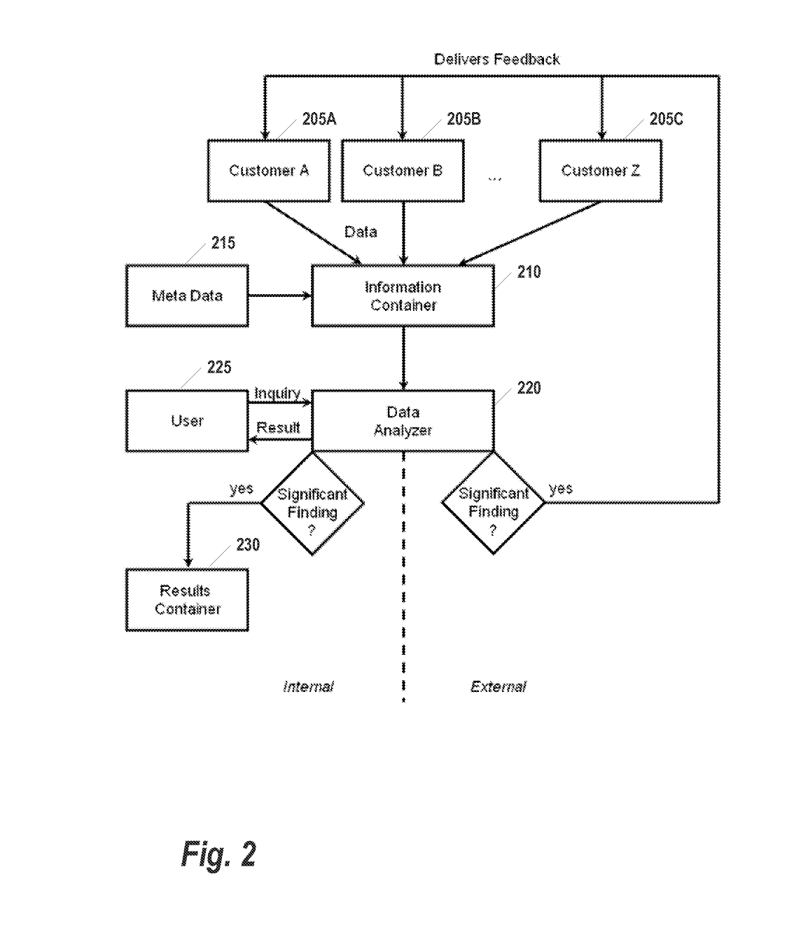

FIG. 2 provides a flow chart illustrating operation of the Usage Monitoring System 105, according to some embodiments of the present invention. An information container 210 dynamically collects current usage data from a set of customers 205A, 205B, 205C. The information container 210 also collects basic information on the medical devices at each customer site and the type of customer utilizing those devices. This data is collectively referred to herein as “meta data.” For example, this information may include modality information (e.g., CT, MR, PET, SPECT), scanner type (e.g., MAGNETOM, SOMATOM), configuration (e.g., hardware or software version), department of the customer (e.g., Radiology, Cardiology, Radiation, Oncology), hospital type, (e.g., community, private practice, teaching hospital), or specialization of the customer (e.g., Cancer Center, Heart Hospital.). In some embodiments, the meta data is part of the usage data. That is, the meta data information is included within the usage data collected from the set of customers. In other embodiments, the meta data is collected separately. For example, in one embodiment, the meta data is collected initially when a device is installed at a customer site. Then, the meta data is periodically updated, for example, during scheduled maintenance of the installed device.

Continuing with reference to FIG. 2, the current usage data collected by the information container 210 is combined with meta data 215 of the customers 205A, 205B, 205C. Subsequently a Data Analyzer 220 categorizes the combined data. In some embodiments, such as the example of FIG. 2, if a significant finding is detected by the Data Analyzer 220, an external feedback loop delivers feedback to customers 205A, 205B, 205C. For example, in one embodiment, an output processor is configured to present any significant finding in an email to one or more customers. In this context, a significant finding may include, for example, statistically significant correlations in the meta data 215 (e.g., identification of a correlation between data sets, identification of trends, etc.). Additionally, in some embodiments the Data Analyzer 220 evaluates findings data and automatically compares it to available data to identify patterns, trends, and correlations. Any results generated by the Data Analyzer may be stored in Results Container 230.

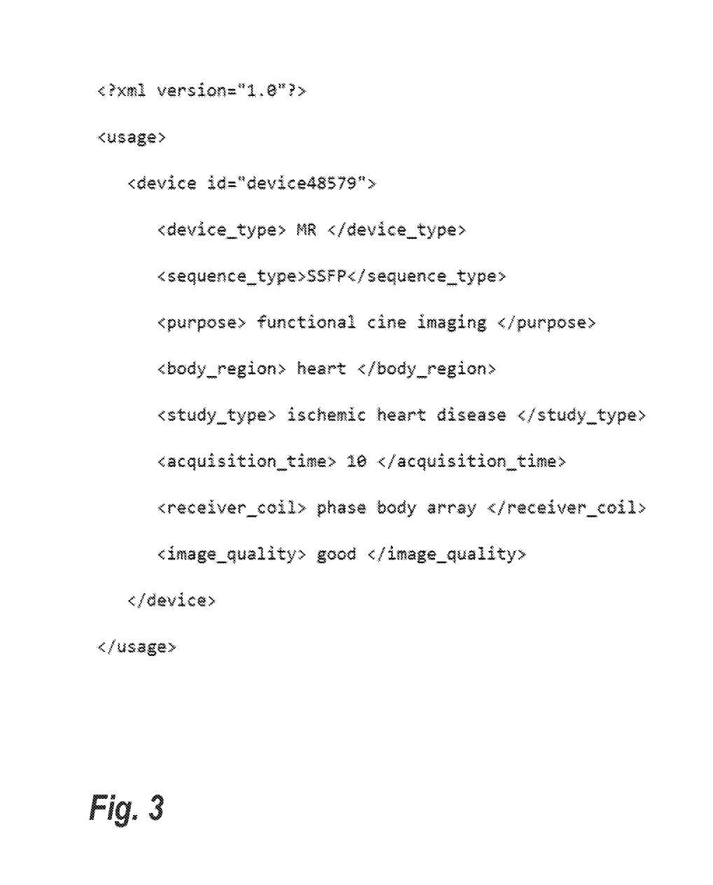

In some embodiments, each medical device is configured to generate a file including usage data for processing by the Usage Monitoring System (e.g., 105 in FIG. 1). This file may be formatted according to any formatting technique known in the art. For example, FIG. 3 provides a XML file showing how usage data may be formatted for transfer to the information container for the example of a MRI study, according to some embodiments of the present invention. This file may be generated, for example, following a single scan or at the conclusion of an imaging session. The file begins with an opening usage tag (<usage>) which indicates that all data which follows, until corresponding terminating tag (</usage>) is usage information. The next line provides a device identifier via the device_id tag. This information may be unique to the machine and may comprise, for example, a serial number or specific number assigned to the device by the operator of the system. Next, a device type tag (<device_type>) specifies that this usage data is associated with an MRI device. The <sequence_tag> indicates that SSFP was used for the acquisition. This tag may also hold other values such as, for example, ECG—gated or breath hold. The purpose tag (<purpose>) is used to specify the purpose of the scan. In the example of FIG. 3, this purpose is for functional cine imaging. The <study_type> tag indicates the type of study being performed by the MRI device, in this case an ischemic heart disease study. The <acquisition_time> specifies, in seconds, the total acquisition time. In other embodiments, different units of measurement may be used. The <receiver coil> tag indicates that phase body array coils were used for the study and the <image_quality> tag specifies that the results of the scan were good. Other quality identifiers may specify that the image quality was, for example, poor or non-diagnostic.

In some embodiments, rather than providing a specific usage file (e.g., in the format of FIG. 3) to the Usage Monitoring System 105, each device sends log information which is then used to derive the usage information associated with each device. For example, most scanners log information about the status of hardware and software components, and these logs are typically used for maintenance and troubleshooting. Various approaches may be used to parse these log files to derive usage information. For example, the system may employ a parsing method specific to each particular medical device or class of medical devices.

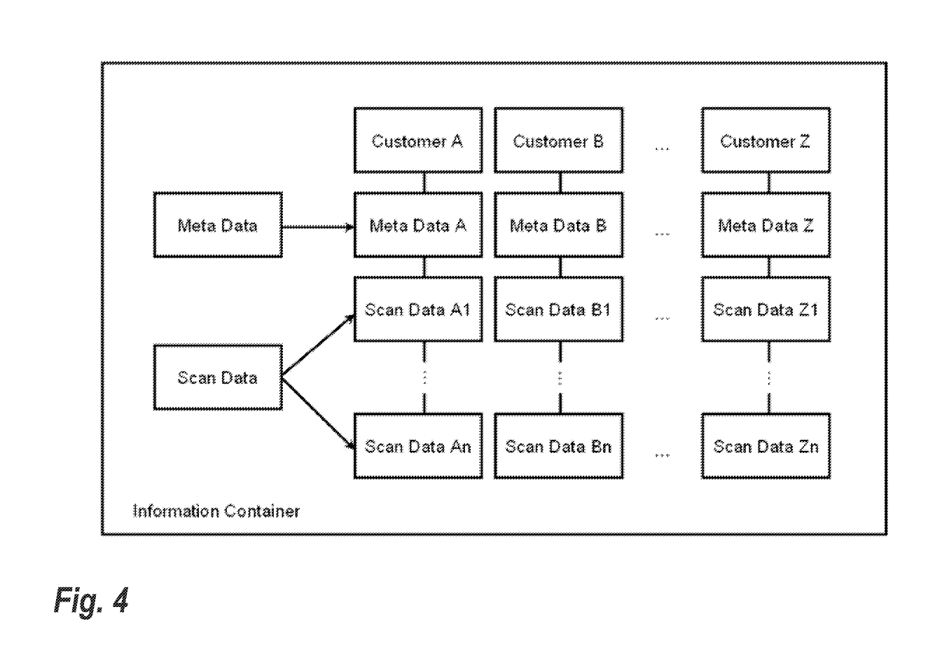

FIG. 4 is a block diagram of an Information Container (e.g., 210 in FIG. 2), as implemented in some embodiments of the present invention. In the example of FIG. 4, all scan data associated with a single customer are stored along with meta data for that customer. In one embodiment, the information container is implemented as a database management system using commercially available systems such as, for example, Oracle, IBM DB2, and Microsoft SQL Server. As new meta data and/or scan data arrives it may be used to update an existing customer record or, if no customer exists, to create a new customer record.

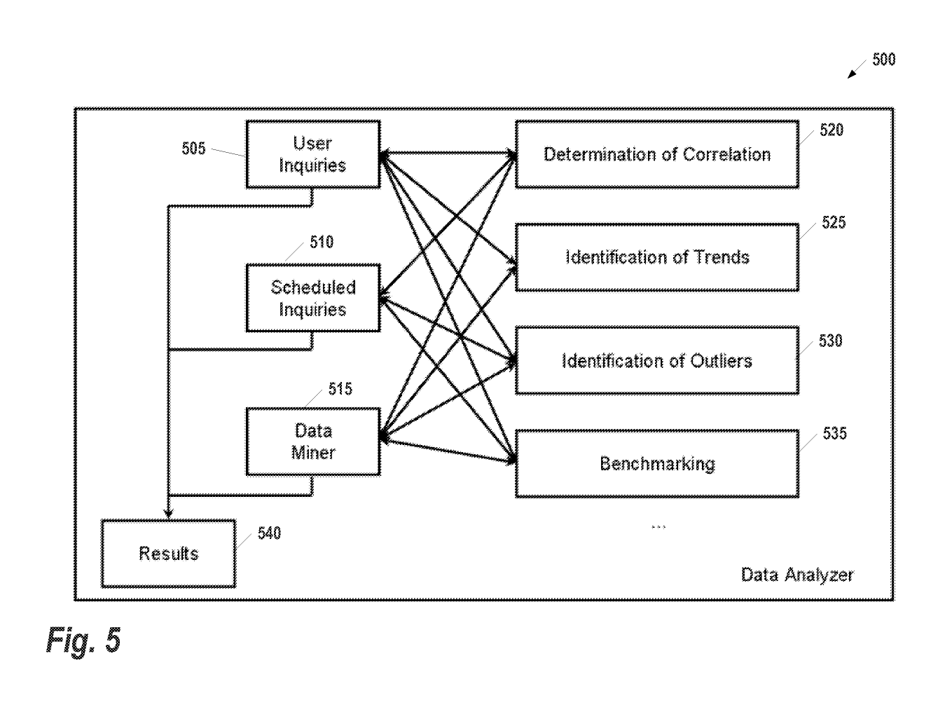

FIG. 5 provides a detailed view of the Data Analyzer 500, as implemented in some embodiments of the present invention. For example, the Data Analyzer 500 of FIG. 5 may be used to implement item 220 in FIG. 2. The Data Analyzer 500 is designed to derive relevant or significant information using the information available in the Information Container (e.g., 210). More specifically, in some embodiments, the Data Analyzer 500 generates results from specific or general inquiries to the Information Container. For example, these inquiries may include user inquires, specific inquires and inquiries generated by a data miner A user inquiry is a one-time request that intends to find answers to specific questions about a single customer (e.g. a hospital) or a group of customer (radiology). An example of a user inquiry is “how often is a technique used by the community?” Scheduled inquiries are regular requests that intend to answer questions about how the usage or a technique changes over time for a specific customer of a group of customers. An example scheduled inquiry is a regular check of the status of hardware elements (e.g. x-ray tube) for individual customers or a group of customers (e.g. a hospital system). A data miner may be used to generate additional inquiries (e.g. by using randomly picked input parameters) to identify trends that may be not yet recognized by the community or counter intuitive. Common analysis modules shared between the various inquiries may include modules for the determination of correlations between two or more parameters, identification of positive or negative trends, identification of outliers, and benchmarking of a specific user or users group against other groups of customers. In some embodiments, additional modules are used to further supplement the functionality of the Data Analyzer. Results from each inquiry are collected and provided as output of the Data Analyzer module.

For example, the Data Analyzer 500 illustrated in FIG. 5 includes three modules 505, 510, 515 for analyzing usage information. The User Inquiries module 505 processes single one-time requests regarding users such as, for example and without limitation, how often is a specific technique used by a single customer; how often is a specific technique used by a specific group of customers; how is the usage of a specific technique changing; and who is a power user of a specific technique. The Schedule Inquiries module 510 processes regularly scheduled inquiries such as, for example and without limitation, a regular check of hardware and software elements and monitoring changes in usage patterns. The Data Miner 515 provides information on unsolicited inquiries such as, for example, the identification of correlation between parameters (e.g., “a high percentage of community hospitals in a specific area are using a specific technique”).

In some embodiments, in order to process the inquiries, the Data Analyzer 500 utilizes a generic set of mathematical and statistical tools. Although many of the inquiries can be processed with simple counting of events, the Data Analyzer 500 may also be adapted to provide higher level analysis. In the example of FIG. 5, a group of modules 520, 525, 530, 535, are used to perform such higher-level analysis. A correlation module 520 is configured to calculate cross-correlations between two or more variables. For example, in one embodiment, correlations are determined to identify groups of customers using a specific technique. A trend identification module 525 is configured to analyze a sample of data points (e.g., usage over time) and identify positive or negative trends of data points. In one embodiment, the Data Analyzer 500 identifies an increase or decrease of a use of a specific technique with a particular device. An outlier identification module 520 is configured to identify data points that are outside of a confidence interval. For example, the Data Analyzer 500 may identify power users of a technique or customers not using a technique at all. A benchmarking module 535 in the Data Analyzer 500 is configured to determine general or specific benchmarking information, for example, by identifying a top percentile of a group of data points. For example, the benchmarking module 535 may identify the best practice usage of a specific technique.

Continuing with reference to FIG. 5, a results module 540 may be used to collect the results of the inquiries and categorizes them as significant or insignificant. In some embodiments, this is performed in automated manner (e.g. “hardware components are wearing out and service needs to be scheduled to replace component”, e.g. Siemens TubeGuard). In other embodiments, the collection and categorization process may be performed semi-automated or fully manually. The results module 540 may also provide feedback directly back to the customer (e.g. “service has been dispatched to replace a component”) or the inquiry may be further refined using the results of his inquiry. For example, in one embodiment, an output processor is configured to present any significant finding in an email to one or more customers.

The results module 540 may also provide information on recommended operational changes. For example, in one embodiment, the results module 540 may be configured to identify an operational problem related to an imaging device in response to identification of a significant finding. Then, the module 540 may further identify an operational change to the imaging device to correct the operational problem. In some embodiments, the identified operational change is then used to generate recommendations, for example, to customers utilizing the imaging device and/or technicians maintaining the imaging the device.

The outputs of the various modules in the Data Analyzer (e.g., 500) can be combined to provide additional insights into customer usage of the medical devices. For example, in one embodiment, the Usage Monitoring System 105 is applied to early adopters of a novel technique (e.g. non-contrast enhanced MR angiographies, non-CE MRA). First, the Data Analyzer identifies customers who have access to a specific feature (e.g. purchased the corresponding option) by analyzing meta data. Then, customers are identified who are frequent users of a technique. By analyzing usage trends, customers can be identified that are adopting novel techniques. In other cases, an outlier analysis may identify customer that are using a novel technique unusually often and can be champions of a novel technique.

The Data Analyzer may include additional modules not shown in FIG. 5. For example, a market analysis module may be used to derive a metric to perform basic market analysis. In some embodiments, the penetration and acceptance of a specific method is derived by interpreting how often a specific method is used in the different market segments. Market segments in healthcare may include, for example, private practices, community hospitals, hospital networks, research hospitals, and teaching hospitals. In some embodiments, dedicated customer groups are identified, such as power users (e.g., high usage of a well-established method), early adopters and trendsetters (e.g., high usage of an emerging method), late adopters (e.g., low usage of a well-established method). In some embodiments, market trends are identified by analyzing how usage of methods and applications change over the course of time.

The results of the Data Analyzer may be utilized in a variety of ways. For example, in some embodiments, the results of the Data Analyzer are used to optimize clinical scan protocols through customer feedback. In one embodiment, in the context of an MRI examination, trends about the specific order and frequency of use of features/sequences/scan settings are recorded. Using feedback similar to the “Like”/“Dislike” feature popular in social networking sites, radiologists may provide feedback about image quality by tagging specific images, and technologists may provide feedback about workflow and scanner performance. Additionally, detailed meta tags describing scan settings may be accumulated and used to, for example, create an archive of preferred imaging protocols, make immediate parameter recommendations to the customer (e.g., recommended operational changes), or plan software/hardware improvements. In some embodiments, the results of the Data Analyzer may also be used for triggering customer training and/or applications support.

In some embodiments, as an analogue to recommender systems, the usage profile of a specific customer is used to understand how a customer is currently using imaging equipment. The system may then derive recommendations for certain product features the customer may not yet be aware of. For example, a customer with a large number of head/neck/spine MR studies may be interested in susceptibility weighted imaging (SWI) or a dedicated MR receiver coil. In some embodiments, a comparison with customers with similar characteristics (e.g., patient population, usage of methods, demographics) results in a recommendation for use of specific features or clinical applications. For example, a hospital in an urban area with an aging population may be interested in specific methods to diagnose degenerative neurological diseases, such as Multiple Sclerosis or Parkinson Disease.

In some embodiments, the results of the Data Analyzer are used to optimize services tailored to customer needs. An implementation may include, for example, a comparison of usage data of a specific customer to a cohort of similar customers. A low usage may indicate, for example, that application training may be required, lack of awareness of the available methods at a specific customer site, technical problems, or clinical irrelevance. As a result, specific training classes may be offered to the customer, optimized protocols may be made available to the customer, or contacts to other experts in the respective fields may be established.

In some embodiments, the results of the Data Analyzer are used to derive information for business use. For example, the results may be used to anticipate customer needs, to generate recommendations of features that fit customer's needs, to target marketing efforts, and/or to identify market penetration of specific applications and market trends. In some embodiments, targeting marketing efforts are derived from the Data Analyzer results indicating dedicated customer groups (e.g. early adopters), market trends (e.g. an emerging method), and/or anticipated needs by customers. For example, a method may be marketed specifically to early adopters (e.g. as trial license, as discounted item) who have access to a particular patient group that the method has been developed for.

To illustrate one example use of the Usage Monitoring System 105, as implemented in some embodiments, consider the task of making business decisions related to the use of Cardiovascular Magnetic Resonance Imaging (CMR). The market share of CMR may be currently small and it is desired to see this market share grow. Thus, vendors may attempt to explore how an environment can be created that fosters the growth of a specific application and increase efforts in specific areas of R&D, marketing strategies, and new markets. In support of this goal, there are a number of high-level queries for CMR that may be posed by vendors including, without limitation: which specific hospitals or types of hospitals are most frequently performing CMR; which hospitals are most frequently performing CMR studies; which department is typically running CMR studies; what are most common clinical applications; what is the commonly used field strength; which are the work horse techniques in CMR; who are early adopters of a novel technique; and did the usage of a specific technique increase? Each of these general queries may be refined and analyzed by the Usage Monitoring System 105. For example, the inquiry “which hospitals are frequently performing CMR studies” may be broken down in sub-inquiries that are passed to the Data Analyzer (e.g. 500 in FIG. 5) which, in turn, may perform a multi-stage analysis. For example, the Data Analyzer may identify customer sites that perform sufficient number of CMR studies per week to qualify as a frequent user (e.g., greater than 20 studies per week on each scanner). In some embodiments, the Data Analyzer may invoke a simple counter of CMR studies per week using the information container to generate a list of customers. Then, the frequent customers may be categorized by kind of customer (e.g. community hospital) by invoking a correlation module provided by the Data Analyzer. In this case, the result of the inquiry is the kind of customer that most frequently uses CMR (e.g. large hospitals).

Continuing with the example of CMR, the results of inquiries may be used to derive business, marketing and R&D tasks. For example, in some embodiments, the system communicates with power users and non-users of a method to identify opportunities and challenges for the method and subsequently target the areas of improvements (e.g. a method used in a new patient group such as CMR in pediatrics with congenital heart disease). In other embodiments, the system learns how methods are being used by customers to prioritize the development of emerging technologies. For example, an increased interest in non-CE MRA may be used to prioritize the development of next generation methods for non-CE MRA. With respect to deriving tasks for business development, in one embodiment, the system identifies business opportunities such as, for example, a group of customers that currently does not use CMR but may benefit from CMR. In other embodiments, the Usage Monitoring System 105 targets markets to specific customers. For example, the System 105 may be used target frequent CMR users that may be interested in other features such as non-CE MRA or offers trial licenses.

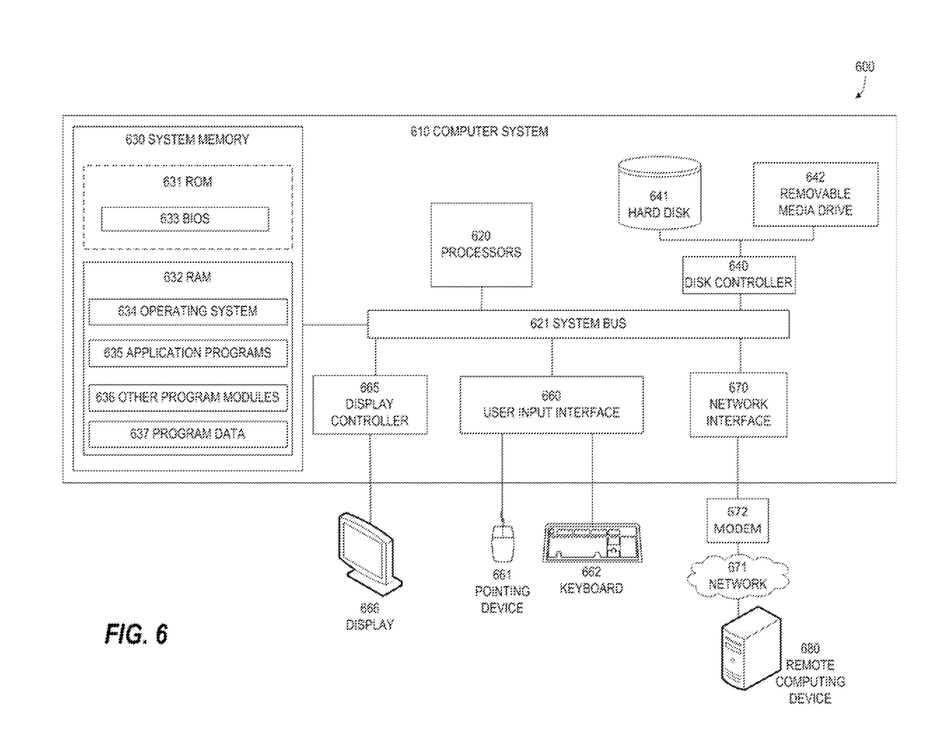

FIG. 6 illustrates an exemplary computing environment 600 within which embodiments of the invention may be implemented. This environment 600 may be used, for example, to implement a portion of one or more components of Usage Monitoring System 105 or computers 110B, 115B, 120B illustrated in FIG. 1. Computing environment 600 may include computer system 610, which is one example of a computing system upon which embodiments of the invention may be implemented. Computers and computing environments, such as computer system 610 and computing environment 600, are known to those of skill in the art and thus are described briefly here.

As shown in FIG. 6, the computer system 610 may include a communication mechanism such as a bus 621 or other communication mechanism for communicating information within the computer system 610. The system 610 further includes one or more processors 620 coupled with the bus 621 for processing the information.

The processors 620 may include one or more central processing units (CPUs), graphical processing units (GPUs), or any other processor known in the art. More generally, a processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

Continuing with reference to FIG. 6, the computer system 610 also includes a system memory 630 coupled to the bus 621 for storing information and instructions to be executed by processors 620. The system memory 630 may include computer readable storage media in the form of volatile and/or nonvolatile memory, such as read only memory (ROM) 631 and/or random access memory (RAM) 632. The system memory RAM 632 may include other dynamic storage device(s) (e.g., dynamic RAM, static RAM, and synchronous DRAM). The system memory ROM 631 may include other static storage device(s) (e.g., programmable ROM, erasable PROM, and electrically erasable PROM). In addition, the system memory 630 may be used for storing temporary variables or other intermediate information during the execution of instructions by the processors 620. A basic input/output system 633 (BIOS) containing the basic routines that help to transfer information between elements within computer system 610, such as during start-up, may be stored in ROM 631. RAM 632 may contain data and/or program modules that are immediately accessible to and/or presently being operated on by the processors 620. System memory 630 may additionally include, for example, operating system 634, application programs 635, other program modules 636 and program data 637.

The computer system 610 also includes a disk controller 640 coupled to the bus 621 to control one or more storage devices for storing information and instructions, such as a magnetic hard disk 641 and a removable media drive 642 (e.g., floppy disk drive, compact disc drive, tape drive, and/or solid state drive). The storage devices may be added to the computer system 610 using an appropriate device interface (e.g., a small computer system interface (SCSI), integrated device electronics (IDE), Universal Serial Bus (USB), or FireWire).

The computer system 610 may also include a display controller 665 coupled to the bus 621 to control a display or monitor 665, such as a cathode ray tube (CRT) or liquid crystal display (LCD), for displaying information to a computer user. The computer system includes an input interface 660 and one or more input devices, such as a keyboard 661 and a pointing device 662, for interacting with a computer user and providing information to the processor 620. The pointing device 662, for example, may be a mouse, a light pen, a trackball, or a pointing stick for communicating direction information and command selections to the processor 620 and for controlling cursor movement on the display 666. The display 666 may provide a touch screen interface which allows input to supplement or replace the communication of direction information and command selections by the pointing device 661.

The computer system 610 may perform a portion or all of the processing steps of embodiments of the invention in response to the processors 620 executing one or more sequences of one or more instructions contained in a memory, such as the system memory 630. Such instructions may be read into the system memory 630 from another computer readable medium, such as a hard disk 641 or a removable media drive 642. The hard disk 641 may contain one or more datastores and data files used by embodiments of the present invention. Datastore contents and data files may be encrypted to improve security. The processors 620 may also be employed in a multi-processing arrangement to execute the one or more sequences of instructions contained in system memory 630. In alternative embodiments, hard-wired circuitry may be used in place of or in combination with software instructions. Thus, embodiments are not limited to any specific combination of hardware circuitry and software.

As stated above, the computer system 610 may include at least one computer readable medium or memory for holding instructions programmed according embodiments of the invention and for containing data structures, tables, records, or other data described herein. The term “computer readable medium” as used herein refers to any medium that participates in providing instructions to the processor 620 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as hard disk 641 or removable media drive 642. Non-limiting examples of volatile media include dynamic memory, such as system memory 630. Non-limiting examples of transmission media include coaxial cables, copper wire, and fiber optics, including the wires that make up the bus 621. Transmission media may also take the form of acoustic or light waves, such as those generated during radio wave and infrared data communications.

The computing environment 600 may further include the computer system 620 operating in a networked environment using logical connections to one or more remote computers, such as remote computer 680. Remote computer 680 may be a personal computer (laptop or desktop), a mobile device, a server, a router, a network PC, a peer device or other common network node, and typically includes many or all of the elements described above relative to computer 610. When used in a networking environment, computer 610 may include modem 672 for establishing communications over a network 671, such as the Internet. Modem 672 may be connected to system bus 621 via user network interface 670, or via another appropriate mechanism.

Network 671 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 610 and other computers (e.g., remote computing system 680). The network 671 may be wired, wireless or a combination thereof. Wired connections may be implemented using Ethernet, Universal Serial Bus (USB), RJ-11, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 671.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the UI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The embodiments of the present invention can be included in an article of manufacture comprising, for example, a non-transitory computer readable medium. This computer readable medium may have embodied therein a method for facilitating one or more of the techniques utilized by some embodiments of the present invention. The article of manufacture may be included as part of a computer system or sold separately.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

We claim:

1. A system for profiling operational usage associated with a plurality of medical imaging devices, the system comprising:
an information container processor configured to acquire operational data from each of a plurality of customer entities, the operational data acquired from each respective customer entity comprising:
an identification of an imaging device used by a respective customer entity,
a configuration setting associated with the imaging device,
an identification of one or more of an imaging scanning method utilized by the imaging device, an anatomical region imaged by the imaging device, and a medical condition investigated using the imaging device;
a database configured to store the operational data acquired from each respective customer entity;
a data analyzer module configured to:
generate one or more usage inquiries,
using the database and the usage inquiries, derive one or more findings regarding the operational data acquired from each respective customer entity, and
identify a significant finding included in the one or more findings; and
an output processor configured to communicate data indicating the significant finding to a destination.

2. The system of claim 1, wherein the data analyzer module is further configured to identify an imaging system feature to offer one or more of the customer entities in response to identification of the significant finding.

3. The system of claim 1, wherein the data analyzer module is further configured to:
identify an operational problem in response to identification of the significant finding, and
identify an operational change to a first imaging device to correct the operational problem.

4. The system of claim 1, wherein the information container processor is configured to acquire the operational data from each of a plurality of customer entities by:
receiving a device log file from each of the plurality of customer entities, and
parsing the received log files to identify the operational data.

5. The system of claim 1, wherein the operational data acquired from each respective customer entity further comprises data identifying one or more of frequency of use of particular hardware included in the imaging device, frequency of use of the imaging scanning method, and a distribution of anatomical regions imaged by the imaging device.

6. The system of claim 1, wherein the operational data acquired from each respective customer entity further comprises data identifying one or more of duration of an individual imaging examination, imaging system failures, a distribution of anatomical regions imaged by the imaging device and data identifying a type of imaging examination performed for a particular anatomical region.

7. The system of claim 1 wherein the customer entities comprise at least one of, (a) a hospital, (b) a group of hospitals, (c) a hospital department, (d) a medical facility, (e) an individual user, and (f) a group of users.

8. A system for analyzing usage information associated with a plurality of medical devices, the system comprising:
a usage information database comprising a plurality of usage information records, each usage information record corresponding to a respective medical device and a user of the respective medical device;
a plurality of inquiry modules configured to process one or more inquiries using the usage information database, the inquiry modules comprising:
a user inquiries module configured to process single one-time requests regarding users of the medical devices,
a scheduled inquiries module configured to process scheduled inquiries regarding the users of the medical devices, and
a data mining module configured to automatically process one or more unsolicited inquiries regarding the users of the medical devices;
a plurality of processing modules operably coupled to the inquiry modules and configured to receive one or more results of the inquiries and derive one or more findings; and
a results module configured to categorize the one or more findings as significant or insignificant.

9. The system of claim 8, wherein the processing modules comprise one or more of:
a correlation module configured to calculate cross-correlations between two or more variables included in the usage information records,
a trend identification module configured to identify a trend across a sample of first data points included in the usage information records,
an outlier identification module configured to identify second data points included in the usage information records that are outside of a predetermined confidence interval, and
a benchmarking module configured to determine benchmarking information based on a predetermined percentile of third data points included in usage information records.

10. The method of claim 9, wherein the cross-correlations calculated by the correlation module identify groups of users performing a specific technique using the medical devices.

11. The method of claim 9, wherein the trend identification module is further configured to identify an increase or decrease of use of a specific technique by a specific user of a specific one of the medical devices.

12. The system of claim 8, wherein the one-time requests comprise one or more of
a first request for how often an imaging technique is performed by a specific user of a specific one of the medical devices,
a second request for how often the imaging technique is performed by each of a first group of users utilizing their corresponding medical devices;
a third request for how usage of the imaging technique by each of a second group of users has changed over a time period, and
a fourth request for identifiers associated with a third group of users performing the imaging technique using their corresponding medical devices.

13. The system of claim 8, wherein the scheduled inquiries comprise one or more of
a first status inquiry requesting hardware status information corresponding to the medical devices, and
a second status inquiry requesting software status information corresponding to the medical devices.

14. The system of claim 8, unsolicited inquiries comprise a request for identification of a correlation between a first parameter and a second parameter based on usage information stored in the usage information database.

15. The system of claim 8, wherein the results module is further configured to transmit a feedback message to one or more of the users of the medical devices.

16. The system of claim 8, further comprising:
a market analysis module configured to derive a market analysis metric based on information stored in the usage information database.

17. An article of manufacture for profiling operational usage of a plurality of medical imaging devices, the article of manufacture comprising a non-transitory computer-readable medium holding computer-executable instructions for performing a method comprising:
acquiring operational data from each of a plurality of customer entities, the operational data acquired from each respective customer entity comprising:
an identification of a imaging device used by a respective customer entity,
a configuration setting associated with the imaging device,
an identification of one or more of an imaging scanning method utilized by the imaging device, an anatomical region imaged by the imaging device, and a medical condition investigated using the imaging device;
storing the operational data acquired from each respective customer entity;
generating one or more usage inquiries;
using the database and the usage inquiries, deriving one or more findings regarding the operational data acquired from each respective customer entity;
identifying a significant finding included in the one or more findings; and
communicating data indicating the significant finding to a destination.

18. The article of manufacture of claim 17, wherein the method further comprises:
identifying an imaging system feature to offer one or more of the plurality of customer entities in response to identification of the significant finding.

19. The article of manufacture of claim 17, wherein the method further comprises:
identifying an operational problem in response to identification of the significant finding, and
identifying an operational change to a first imaging device to correct the operational problem.

20. The article of manufacture of claim 17, wherein the operational data is acquired from each of a plurality of customer entities by:
receiving a device log file from each of the plurality of customer entities, and
parsing the received log files to identify the operational data.
